(19) United States
(12) Patent Application Publication
(10) Pub. No.: US 2021/0298980 A1
(43) Pub. Date: Sep. 30, 2021

(54) Spinal Alignment System and Method

(71) Applicant: Karena Thek, Alexandria, VA (US)

(72) Inventor: Karena Thek, Alexandria, VA (US)

(21) Appl. No.: 16/829,428

(22) Filed: Mar. 25, 2020

(51) Int. Cl. A61G 13/00; A61G 13/12; A63B 21/04; A63B 21/00; A63B 71/00

(52) U.S. Cl. CPC A61G 13/009; A61G 13/122; A63B 71/0036; A63B 21/0442; A63B 21/4039; A61G 13/1285

(57) ABSTRACT

A method of use and a spinal alignment system that comprises a wedge-shaped cushioning device with a plurality of attachment points, a thoracic member that is detachably attached to the wedge-shaped cushioning device and resilient members.

### BACKGROUND OF THE INVENTION

### Field of Invention

This invention relates to a spinal alignment system for assisting in the alignment of the spine into a neutral position, by allowing users to use the system for therapeutic exercises at home or in a clinical setting. More specifically the invention relates to a system which allows for support of improved alignment in various degrees of spinal traction while the user is in an inverted prone position. The spinal alignment system that comprises a wedge-shaped cushioning device with a pelvic ledge for placement of a user's pelvis and attachment points which allows the attachment of resistive elements that users can use for strengthening exercises and a thoracic member which allows the user a degree of flexibility while in an inverted prone position. The system also allows gravity to assist the spine and lower extremities to fall in traction by pulling the spine and lower extremities away from the pelvis, while allowing users with varying degree of spinal flexibility, mobility, and pain to customize the system through use of the various components, such as a wedge-shaped cushioning device, thoracic member and resistive elements. As a tool for professional practitioner, it allows the practitioner to place their patient in an ideal spinal alignment before applying manual therapy techniques. Improved posture, alignment and strength will reduce pain and allow users to return to the daily activities that they enjoy with less pain, improved posture, alignment and strength.

### Description of Related Art

It is unfortunate that those suffering from back pain or a spine deformity are suffering needlessly. They try ineffective, self-created stretches that they do at home and at work. They watch videos online that offer unreliable advice and no result. They buy large pieces of equipment in hopes of easing their discomfort or equipment that does not have the adequate firmness to support their spine. While some of these pieces of equipment may invert the body and give a gravity-assisted traction and some offer options for strengthening the spine, none do both. In addition to self-created stretches and purchases of cumbersome exercise equipment, those suffering from back pain attend classes to become stronger and attend different classes to become more flexible. All these activities result in increased frustration, as the source of the problem has not been cared for: improved alignment with strengthening to maintain the improved alignment.

Another type of problem exists when patients seek professional help for their back pain or spine deformity. They see a medical doctor who gives them a prescription for physical therapy. Once in physical therapy, most patients only see a physical therapist once or twice a week. These infrequent visits are problematic as improved alignment with strengthening must happen daily while the patient's pain is healing. Seeing a physical therapist more frequently is impractical as everyday responsibilities do not allow for a daily visit to a physical therapy clinic. In addition, if a patient were to see a physical therapist every day, typical medical insurance would not pay for that kind of visit frequency. That leaves the patient paying out-of-pocket for daily visits, which quickly becomes expensive and cost prohibitive. As an alternative to these daily physical therapy visits, physical therapists give patients home exercise programs to perform but patients do not do the exercises because either they do not understand them, or they hurt. Often the exercises create more pain because the patients have been unable to position their bodies in the correct position.

An additional problem exists for the therapist who attempts to apply manual therapy techniques to their patients in order to improve spinal alignment. Instead of improving the alignment first, and then applying manual therapies to secure the new alignment, the therapist often fights through the misalignment. Fighting through the misalignment, provides little to no change for the patient. There have been many prior arts who have attempted to solve this problem.

Prior art U.S. Pat. No. 5,697,112 Colavito et al. teaches a wedge-shaped therapy pillow with a planar recess. The wedge-shaped pillow is made of foam with a recess in which a flexible plastic container can be placed in. The pillow is used by a user that suffers from gastroesophageal reflux disease (GERD). The user positions their back on the slope of the wedge-shape pillow.

Prior art U.S. Pat. No. 6,324,710 Hernandez et al. teaches a foam support device that supports and elevates the torso of a patient in a prone position, resists lateral movement or lateral rotation of a patient, and provides an elongated cushion extending laterally for additional elevation of the pelvis or chest of the patient. The support system aids a practitioner in performing spinal taps and punctures by maximizing cervical flexion of the spinal column.

Prior art Sakata et al. U.S. Pat. No. 7,966,679 teaches a stretch assisting cushion for providing assistance to users doing leg-splitting exercises. The user's hips are positioned on a wedge-shaped cushion. The wedge-shaped cushion comprises multiple layers of elastic material adhered to one another.

Prior art Hauptmann U.S. Pat. No. 8,632,443 teaches a therapeutic-exercise pillow that incorporates resistance bands for the user to use while performing strengthening exercises. The therapeutic-exercise pillow comprises multiple layers of foam with varying degrees of firmness. The pillow has a tear drop shape with a flat bottom and only has a pair of attachment members, in which the user can attach resistance bands to.

Prior art U.S. Publication No. 2008/0176725 Mehendale teaches an abdominal size reducer assembly that has a pelvic and lower back support, in which a user while lying on their back can position the assembly underneath them. The pelvic and lower support comprises multiple layers of plywood, high density polyurethane, sponge and foam leather.

Prior art Leier et al. U.S. Pat. No. 8,556,787 teaches an inversion suspension exercise device that comprises a table that is rotatably attached to a base support with a hangar bar, for allowing the user to rotate the table relative to the base support, and do various inversion or suspension exercises. The device may only be used to support the back and waist portions of the user and does not allow for gradual “spinal inversion” and maintaining a “neutral alignment” while strengthening.

Accordingly, there exists a need for a method and apparatus for allowing a patient with back pain or spine deformity to easily perform “spinal inversion” and maintain “neutral alignment” while strengthening. There exists a need for firm support while in “spinal inversion” where the spine and legs can be pulled away from the pelvis towards a “neutral alignment” while simultaneously being able to strengthen thereby maintaining the “neutral alignment”. These elements of traction and strengthening occurring together is of utmost importance when considering how the neuro-muscular system works. If alignment is improved with traction, and there is nothing happening in the body neurologically or muscularly to maintain the alignment, then the body lets the improved alignment go once the traction is complete and the patient is returned to an upright position. Likewise, if a patient practices strengthening while maintaining a less than ideal alignment, than the poor position is confirmed and strengthened neurologically and muscularly. Either way, with traction alone or with strengthening alone, the desired change in back pain or spinal deformity will not be accomplished.

### SUMMARY OF THE INVENTION

The present invention is directed to a spinal alignment system and method of use, that allows a safe and effective exercise program for “spinal inversion,” spine traction and strengthening to allow users with back and spinal deformities to participate in regular exercise programs to achieve lasting results. The invention provides a spinal alignment system with a firm wedge-shaped cushioning device, a firm thoracic member and resistive elements that can be detachably attached to the wedge-shaped cushioning device. An attached carrying handle allows for ease in storage and transportation. The invention overcomes the shortcomings and disadvantages of the prior art by providing a firm surface that provides support in the alignment of the pelvic region and spine, while reducing the possibility of misalignment of the spine and hips when the spine is in traction. In addition, the wedge-shaped cushioning device's pelvic ledge overcomes the shortcomings and disadvantages of the prior art by allowing the spine and legs to be positioned away from the pelvic region thereby improving spinal alignment. The wedge-shaped cushioning device has a plurality of attachment points strategically placed to allows the attachment of resistive elements, without compromising the “neutral spinal” positioning. The addition of the resistive elements allows for simultaneous traction and strengthening to neuro-muscularity and confirms to new alignment, unlike any of the prior art. The size and portability of the invention overcome the cumbersome inversion and traction devices demonstrated in prior art.

### BRIEF DESCRIPTION OF THE DRAWINGS

The accompanying drawings, which are incorporated in and constitute a part of this specification, illustrate an implementation of the invention and, together with the description, explain the goals, advantages and principles of the invention. Corresponding reference numerals indicate corresponding parts throughout the several views of the drawings. In the drawings:

FIG. 1 is a side view of an embodiment of the spinal alignment system with the wedge-shaped cushion device and the thoracic member.

FIG. 2 is an isometric view of the wedge-shaped cushion device.

FIG. 2a is a top view of the wedge-shaped cushioning device.

FIG. 3 is an isometric view of the thoracic member.

FIG. 3a is a sectional view along line B-B of the thoracic member.

FIG. 4 is an embodiment of users using the spinal alignment system.

FIG. 4a-f are embodiments of users using the spinal alignment system with the resilient elements.

FIG. 5 is an embodiment of a professional using the spinal alignment system on a patient.

### DETAILED DESCRIPTION OF THE INVENTION

The spinal alignment system is designed for users who want to perform therapeutic and rehabilitative exercises, post-rehabilitative exercises, spine strengthening exercises for reduction in pain and improved spine health, Pilates-types exercise and general fitness. The preferred embodiment encompasses detachable features to allow users with different abilities, mobility, and different levels of pain rehabilitation. The system allows the user to exercise without further injuring themselves or aggravating the pain that is experienced. The system is designed to portable and easily stored by users in various setting, for example at home or in clinical settings.

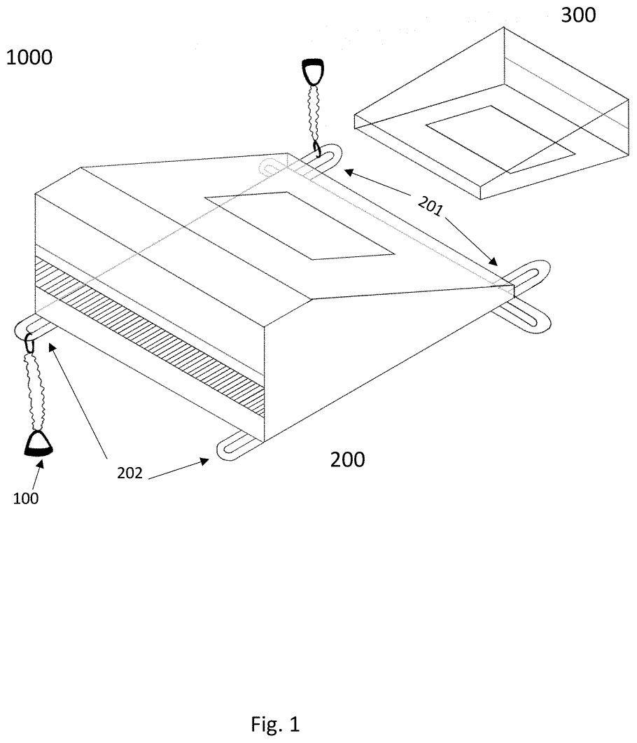

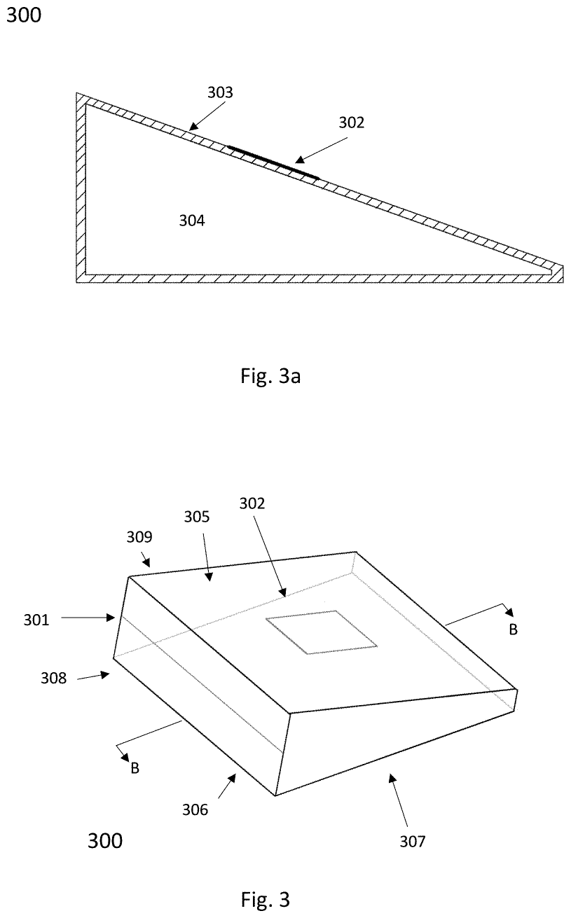

Referring to the Figures wherein like numerals indicate like or corresponding parts through the several views, the typical embodiment encompasses a spinal alignment system generally indicated as 1000 in FIGS. 1-5 that facilitates traction of the spine and exercises to be performed for the reduction of pain and improvement of spinal health.

Referring to FIG. 1, the spinal alignment system 100 includes embodiments that incorporate a wedge-shaped cushioning device 200 with a plurality of forward and rear attachment point 201 and 202 that resistive elements 100 can be attached to and a thoracic member 300. The wedge-shaped cushioning device 200 has an attachment surface 205 on the sloped support surface 211, in which the thoracic member 300, which also has an attachment surface 302 on the sloped surface 305, can be detachably attached to.

The spinal alignment system 1000 allows the user to attach resistive elements 100, for use with the arms and legs of a user, when the user is performing strengthening exercises. The system's 1000 thoracic member 300 can be attached to the wedge-shaped cushioning device 200, through a hoop-and-loop system, to provide users with an easier starting point with less spinal inversion and therefore less traction, allowing the user to gradually improve spine health.

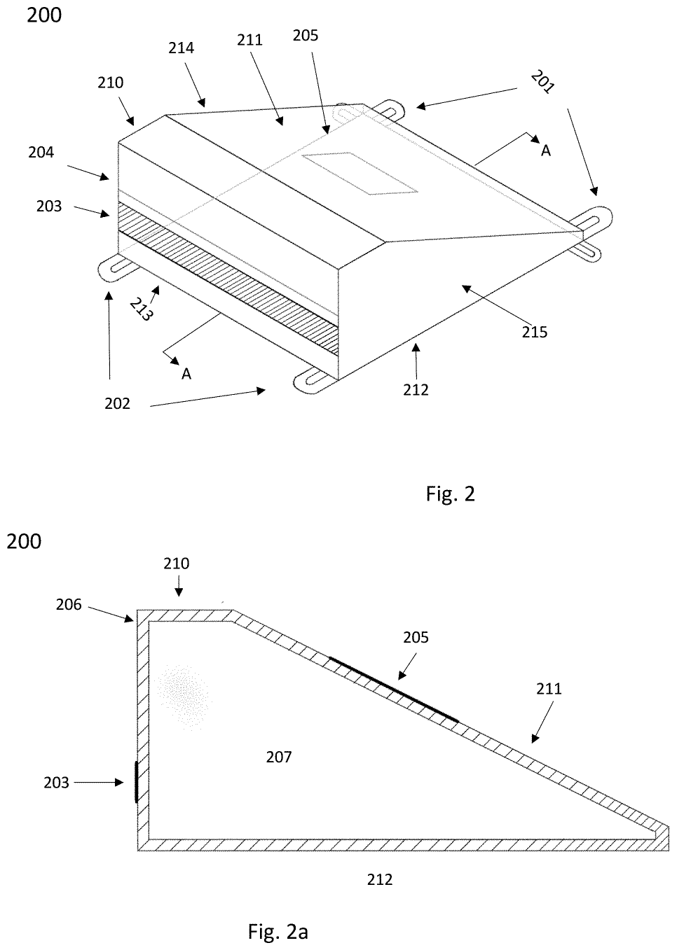

Referring to FIGS. 2 and 2a, the wedge-shaped cushioning device 200 has a shape similar to a right trapezoid, with a pelvic ledge 210, a sloped support surface 211, a bottom surface 212, a first side 214, a second side 215, and a pelvic support side 213. The pelvic support side 213 is designed to have a height that allows the user to position the legs and pelvic region in a position of optimal for achieving a “neutral spine” positioning. In an embodiment, the wedge-shaped cushioning device 200 also has a plurality of forward attachment point 201 that are sewn into the seam of the wedge-shaped cushioning device 200 between the bottom surface 212 and the sloped support surface 211 and a plurality of rear attachment points 202 are sewn into the seam of the wedge-shaped cushioning device 200 between the bottom surface 212 and the pelvic support surface 211. In another embodiment, the wedge-shaped cushioning device 200 also has a plurality of forward attachment point 201 that are sewn into the seam of the wedge-shaped cushioning device 200 between the bottom surface 212 and the first side 214 and between the bottom surface 212 and the second side 215 and the rear attachment points 202 are sewn into the seam of the wedge-shaped cushioning device 200 between the bottom surface 212 and the pelvic support surface 211. The positioning of the plurality of forward and rear attachment points 201 and 202 allow a plurality of resistive elements 100 to be removably attached and can be used to facilitate effective neuro-muscular education of the spine through movement of the extremities.

Still referring to FIG. 2, a key aspect of the wedge-shaped cushioning device 200 is the strategic shape of the internal cushion structure 207, as well as the strategic positioning of the plurality of forward and rear attachment points 201 and 202. The addition of the pelvic ledge 210 at the apex of the device's 200 height allows for a “neutral alignment” of the pelvis, thus allowing for less tension in the spine and thereby an improved positioning of the spine towards a “neutral position”.

Referring to FIG. 2A the wedge-shaped cushioning device 200 has a shell 206 composed of stretch vinyl, vinyl or some sort of cloth. Stretch vinyl is particularly suitable, allowing the shape of the wedge-shaped cushioning device 200 to be maintained and is cleaned easily. The wedge-shaped cushioning device 200 has an easy-access means to the internal cushion structure 207 in the form of a zipper 204 that extends between the first and second side 214 and 215 on the pelvic support side 213. The wedge-shaped cushioning device has a handle 203 that is positioned on the pelvic support side 213. The handle 203 is a polypropylene nylon webbing sewn into the seams of the pelvic support side 213 between the first and second sides 214 and 215. The handle 203 can be installed at a variety of heights, relative to the bottom surface 212, and still be effective. The handle 203 makes the wedge-shaped cushioning device 200 portable and allows the user to easily move the wedge-shaped cushioning device 200 into place for use and to return the spine wedge pillow to storage after use.

The wedge-shaped cushioning device's 200 internal cushion structure 207 is a firm foam with a density of approximately 2.0 pound mass per cubic foot (lbm/ft³) and has an indentation load deflection rating of approximately 55. The firmness of the internal cushion structure 207 allows the user to place their body in a manner in which supports a “neutral spine” positioning without the weight of the user's body collapsing the internal cushion structure 207. When the weight of the user's body is able to collapse the internal cushioning structure 207, the spine will not achieve a “neutral spine” positioning and could cause the spine to remain under tension.

The various embodiments of the wedge-shaped cushioning device 200 allows the device 200 to be scaled up or down in size to meet various practical application needs, such as sizing to meet the torso length of a given user. The wedge-shaped cushioning device 200 is sized to have a dimension of 22 inches in length and 20 inches in width. The height of the pelvic support side 213 is 9 inches and the low point of the sloped support surface 211 is 1 inch. The pelvic ledge 210 has a width of 6 inches. This sizing of the wedge-shaped cushioning device 200, that is suitable for a user that are at and above 5 feet 6 inches in height. In another embodiment the wedge-shaped cushioning device 200 is sized to have a dimension of 22 inches in length and 20 inches in width. The height of the pelvic support side 213 is 8 inches and the low point of the sloped support surface 211 is 0.5 inch. The pelvic ledge 210 has a width of 4 inches. This sizing of the wedge-shaped cushioning device 200 is suitable for users that are at and under 5 feet 5 inches in height. The height difference between the pelvic ledge 210 and the bottom surface 212 and the angle of the sloped support surface 211 allows for gravity-assisted traction of the spine, which in turn allows for a downward pull of the user's legs with gravity to correctly position the user's pelvis and spine.

Referring to FIGS. 3 and 3a, the thoracic member 300 has a shape similar to a wedge, with sloped surface 305, bottom surface 306, a first side 307, a second side 308, and a third side 309. The shape and size of the thoracic member 300 allows a user that is not capable of reaching the prone inversion position on the wedge-shaped cushioning device 200, due to decreased flexibility or kyphosis to be positioned in a prone inversion position without adversely affecting the user's spine. The thoracic member 300 has a shell 303 composed of stretch vinyl, vinyl or some sort of cloth. Stretch vinyl is particularly suitable, allowing the shape of the thoracic member 300 to be maintained and is cleaned easily. The thoracic member 300 has an easy-access means to the internal cushion structure 304 in the form of a zipper 301 that extends between the first and second side 307 and 308 on the third side 309.

The thoracic member's 300 internal cushion structure 304 is a firm foam with a density of approximately 1.8 pound mass per cubic foot (lbm/ft³) and has an indentation load deflection rating of approximately 45. The firmness of the internal cushion structure 304 allows the user to place their body in a manner in which supports a “neutral spine” positioning without the weight of the user's body collapsing the internal cushion structure 304.

The thoracic member 300 is sized to have a dimension of 10 inches in length and 12 inches in width. The length of the sloped surface 305 is 10.5 inches, the height of the third side 309, where the sloped surface 305 meets the third side 309, is 4 inches. The height of where the sloped surface 305 meets the bottom surface 306 is 1 inch.

Referring to FIGS. 1-5, to enhance the decompression of the spine while using the wedge-shaped cushioning device 200 and to confirm the shape neurologically and muscularly through exercise, there are a plurality of forward and rear attachment points 201 and 202 in each of the four corners as a means of connecting a plurality of resistive elements 100, such as, for example, Stroops® or Theraband®. The plurality of forward and rear attachment point 201 and 202 can be a “D” ring. In many variations, each of the plurality of forward and rear attachment point 201 and 202 is coupled to the wedge-shaped cushioning device 200 by a segment of polypropylene nylon webbing sewn into the seams of the wedge-shaped cushioning device 200.

The plurality of resistive elements 100 to be used with the plurality of forward and rear attachment point 201 and 202 are designed to be detachably couple to the plurality of forward and rear attachment point 201 and 202 according to the type of connectors. For example, if the connector means is a mechanical clip device, the plurality resistive elements 100 to be attached would necessarily clip onto the plurality of forward and rear attachment point 201 and 202. It should be noted that in one preferred embodiment, there are a plurality of forward and rear attachment point 201 and 202; however, it should be appreciated that it is envisioned that in other embodiments, additional attachment means can be added to the wedge-shaped cushioning device 200. For example, a third pair of forward attachment points 201 can be installed at any median point at the base of the pillow between the anteriorly and rear attachment points 202. In many embodiments, the wedge-shaped cushioning device 200 comprises a plurality resistive elements 100 of a lighter resistance than the plurality resistive elements 100 attached to the plurality of rear attachment points 202 and a plurality of resistive elements 100 of a heavier resistance than the plurality of resistive elements 100 attached to the plurality of forward attachment points 201 wherein each plurality of resistive elements 100 is comprised of a flexible elastic material. Each plurality of resistive elements 100 have a means for attachment, adapted to allow a user to substantially secure the user's hands and feet in order to facilitate resistance exercises using the user's corresponding arms and legs. In many variations of this embodiment, each of the plurality of resistive elements 100 is elastic.

In the case of any plurality of resistive elements 100 attached to the plurality of forward and rear attachment point 201 and 202, the attachment can be fixed in some embodiments, but in most embodiments the plurality of resistive elements 100 will be detachably coupled by way of some sort of mechanical clip device, mechanical snap, hook-and-loop fastening, or even the mere tying of one end of a strap of a given plurality of resistive elements 100 to the plurality of forward and rear attachment point 201 and 202.

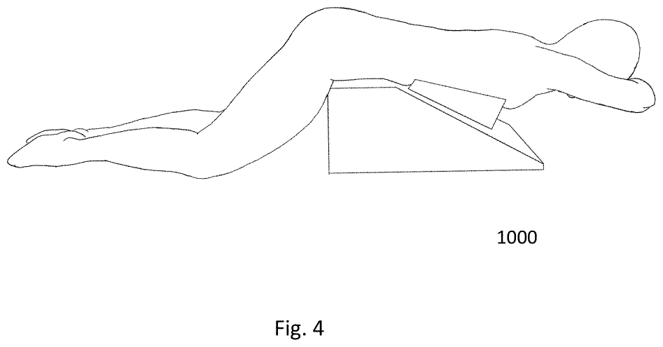

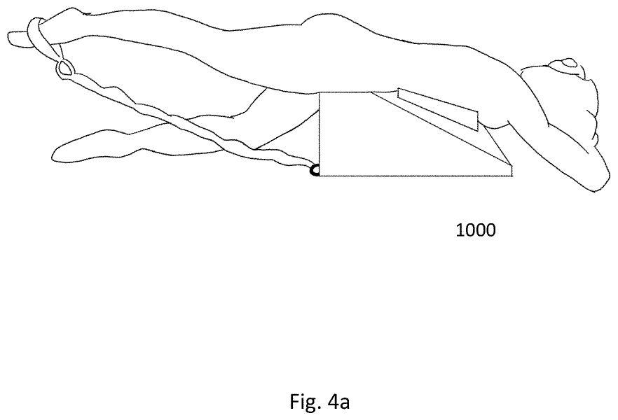

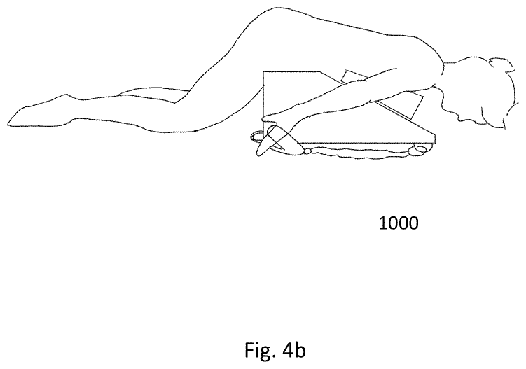

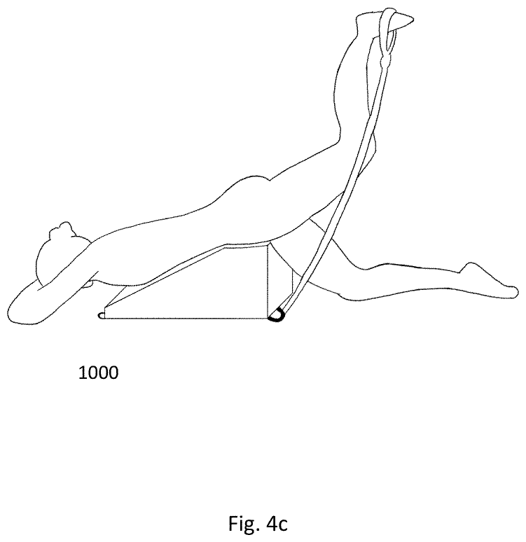

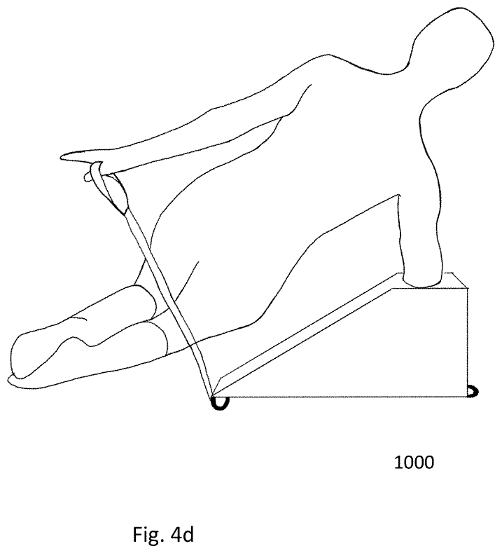

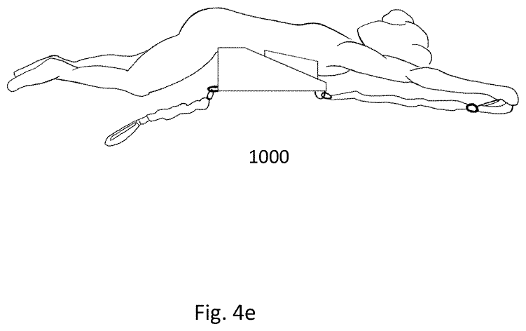

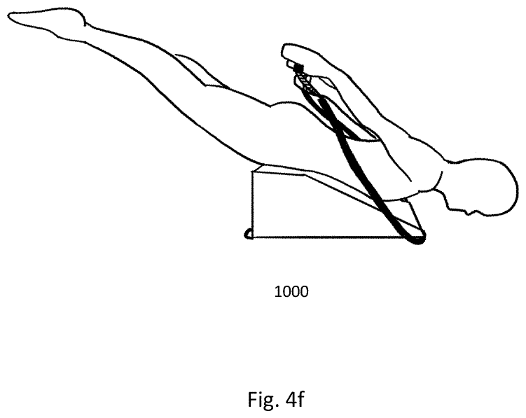

Referring to FIG. 4, a user using the spinal alignment system 1000 in a rest or starting position is demonstrated. Overall, for most embodiments, the spinal alignment system 1000 is adapted to support an improved alignment of the spine with placement of the pelvis on the pelvic ledge 210 with the spine moving downwards along the sloped support surface 211 so that the vertebrae of the spine can decompress in inversion while being supported by the wedge-shaped cushioning device 200. As the pelvis is settled on the pelvic ledge 210, the legs are able to drop away from the pelvis, further creating a release of tension in the hips and spine. The position can be used for rest or for deep breathing exercises that neuro-muscularly confirm the improved alignment of the spine. This starting position is then followed by using the resistive elements 100 to allow for strengthening to take place to neurologically and muscularly confirm the improved alignment.

Referring to FIGS. 4a-f, six exercises are demonstrated on the spinal alignment system 1000. For example, a hip and spine extension exercise is shown in FIG. 4a; an arm and spine extension exercise is shown in FIG. 4b; a flexed foot hip extension exercise with spine stabilization is shown in FIG. 4c; a side plank exercise with spine stabilization is shown in FIG. 4d; an end position for elbow extension is shown in FIG. 4e; and, a hip extension with arm extension and spine stabilization is shown in FIG. 4f. The inventor envisions numerous additional exercises that can be performed but are not shown here. For example, various types of warm-up exercises, stretches, general fitness exercises, therapeutic exercises, stabilization exercises, and assistive exercises where a professional therapist is assisting the user can be performed, with the exercises being tailored to the user's needs.

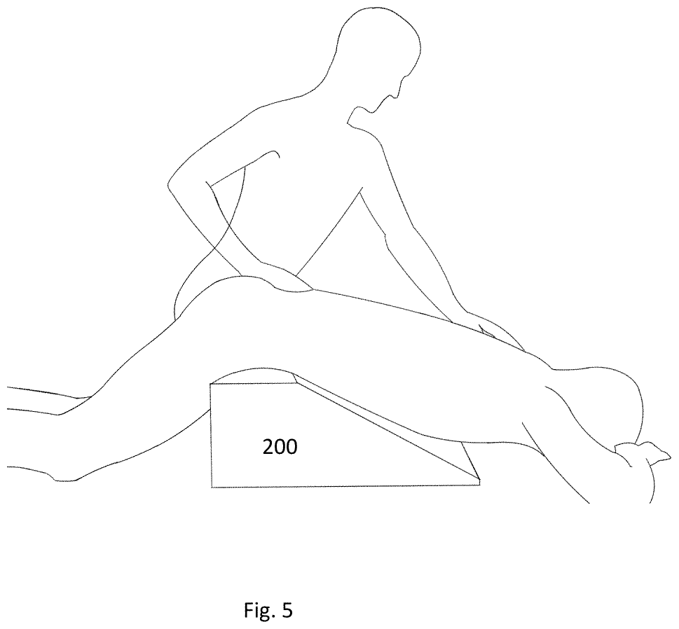

Referring to FIG. 5, a user using the spinal alignment system 1000 on a patient. A therapist places the user in the proper position to allow for an improved alignment before applying manual therapy techniques. With the spinal alignment improved and the muscular tissues returned to a more physiologically normal position, the therapist is able to create lasting change for their patient with manual therapy techniques.

The present disclosure includes that contained in the appended claims as well as that of the forgoing description. Although this invention has been described in its preferred embodiment with a certain degree of particularity, it is understood that the present disclose of the preferred embodiment has been made only by way of example and that numerous changes in the details of construction and the combination and arrangement of parts may be resorted to without departing from the scope and spirit of the invention.

Unless expressly stated otherwise herein, ordinary terms have their corresponding ordinary meaning within the respective contexts of their presentations, and ordinary terms of the art have their corresponding regular meaning.

### Terminology

The terms and phrases as indicated in quotes (“ ”) in this section are intended to have the meaning ascribed to them in this Terminology section applied to them through this document, including the claims, unless clearly indicated otherwise in context. Further, as applicable, the stated definitions are to apply, regardless of the word or phrase's case, to the singular and plural variations of the defined word or phrase.

The term “or”, as used in this specification and the appended claims, is not meant to be exclusive; rather, the term is inclusive, meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of the phrase “in one embodiment” and/or “In one variation” in various places in the specification are not necessarily all meant to refer to the same embodiment.

The term “couple” or “coupled”, as used in this specification, refers to either an indirect or a direct connection between the identified elements, components, or objects. Often the manner of the coupling will be related specifically to the manner in which the two coupled elements interact.

The term “removable”, “removably coupled”, “readily removable”, “readily detachable”, and similar terms, as used in this patent application specification (including the claims and drawings), refers to structures that can be uncoupled from an adjoining structure with relative ease (i.e. non-destructively and without a complicated time-consuming process) and can be readily reattached or coupled to the previously adjoining structure.

Direction and/or relational terms such as, but not limited to, left, right, nadir, apex, top, bottom, vertical, horizontal, back, front, and lateral are relative to each other, are dependent on the specific orientation of an applicable element or article, are used accordingly to aid in the description of the various embodiments, and are not necessarily intended to be construed as limiting.

The terms “cushion”, “wedge cushion”, and “spine wedge cushion”, and similar term, as used in this patent application specification (including the claims and drawings), refers to any type of pliable device used to support a user's body weight, or part of a user's body weight, with some padding or cushioning capability to reduce the impact and stress on the user's body while exercising.

The term “neutral alignment”, as used in this patent application specification (including the claims and drawings), refers to an ideal user's spinal position including the pelvis. The proper posture of the “neutral alignment” is the proper alignment of the body between postural extremes. In its natural alignment the spine and pelvis are not straight; rather, it has curves in the thoracic (upper) and lumbar-pelvic (lower) regions. There is a slight forward curve in the lumbar-pelvic region (lordosis) and a slight backward curve in the thoracic region (kyphosis) and a slight extension in the cervical vertebrae at the top of the spine. According to professionals in the field of body mechanics, neutral alignment is a position where the body is able to ideally function and move.

The term “spinal inversion” refers to the position where the spine has been placed in a position to allow gravity to pull the head downwards. The spine is no longer in opposition to gravity where compression of the spine occurs but is moving, head first in the direction of gravity. This position takes gravitational pressure off the nerve roots and discs of the spine. Space between the vertebrae is increased.

I claim:

1. A spinal alignment system comprising:
a wedge-shaped cushioning device; and
a thoracic member;
wherein the thoracic member is detachably attached to the wedge-shaped cushioning device.

2. The system according to claim 1, wherein the wedge-shaped cushioning comprises a pelvic ledge, a sloped support surface, a bottom surface, a first and second side and a pelvic support side.

3. The system according to claim 1, further comprising a plurality of attachment points, positioned on the outer corners of the wedge-shaped cushioning member.

4. The system according to claim 3, wherein the plurality of attachment points further comprises a plurality of forward attachment points and a plurality of rear attachment points.

5. The system according to claim 4, wherein the plurality of forward attachment points are positioned between the sloped support surface and bottom surface of the wedge-shaped cushioning device and/or the plurality of forward attachment points are positioned between the first and second side surface and bottom surface of the wedge-shaped cushioning device.

6. The system according to claim 3, further comprising a plurality of resistive elements detachably attached to the plurality of attachment points.

7. The system according to claim 1, wherein the wedge-shaped cushioning device further comprises an attachment surface on the sloped support surface.

8. The system according to claim 1, wherein the wedge-shaped cushioning device comprises a firm polyurethane foam.

9. The system according to claim 1, wherein the wedge-shaped cushioning device comprises a stretched vinyl shell.

10. The system according to claim 1, wherein the thoracic member comprises a sloped upper surface, a bottom surface and a first and second side.

11. The system according to claim 1, wherein the thoracic member further comprises an attachment surface on the sloped upper surface.

12. The system according to claim 1, wherein the thoracic member comprises a firm polyurethane foam.

13. The system according to claim 1, wherein the thoracic member comprises a stretch vinyl shell.

14. The system according to claim 1, wherein the wedge-shaped cushion comprises a carrying strap on the pelvic support side.

15. The system according to claim 1, wherein the wedge-shaped cushion has a first height about 0.5 inch;
a second height about 8 inches;
a length about 22 inches;
a first width about 20 inches; and
a second width about 4 inches.

16. The system according to claim 1, wherein the wedge-shaped cushion has a first height about 1 inch;
a second height about 9 inches;
a length about 22 inches;
a first width about 6 inches; and
a second width about 4 inches.

17. The system according to claim 1, wherein the thoracic member has a first height about an inch;
a second height about 4 inches;
a first length about 10.5 inches;
a second length about 12 inches; and
a width about 10 inches.

18. A method of using the system according to claim 1, wherein the user positions their body in a prone position on top of the wedge-shaped pillow and thoracic member;
and positions their pelvic on the pelvic support surface.

19. A method of using the system according to claim 6, wherein the user attaches the plurality resilient elements to the plurality of attachment points;
positions their body in a prone position on top of the wedge-shaped pillow and thoracic member;
positions their pelvic on the pelvic support surface; and
positions their arms and legs to use the resilient elements.
